(19) United States
(12) Patent Application Publication
(10) Pub. No.: US 2026/0020019 A1
(43) Pub. Date: Jan. 15, 2026

(54) SYSTEMS AND METHODS FOR FEEDBACK INFORMATION TRANSMISSION

(71) Applicant: ZTE CORPORATION, Shenzhen (CN)

(72) Inventors: Xing LIU, Shenzhen (CN); Xianghui HAN, Shenzhen (CN); Wei GOU, Shenzhen (CN); Shuaihua KOU, Shenzhen (CN)

(73) Assignee: ZTE CORPORATION, Shenzhen (CN)

(21) Appl. No.: 19/331,055

(22) Filed: Sep. 17, 2025

Related U.S. Application Data
(63) Continuation of application No. PCT/CN2023/082618, filed on Mar. 20, 2023.

(51) Int. Cl. H04W 72/1268; H04L 5/00; H04W 72/231

(52) U.S. Cl. CPC H04W 72/1268; H04L 5/0044; H04W 72/231

(57) ABSTRACT

The present disclosure relates to systems, apparatuses, non-transitory computer-readable media, and methods for sending, by a network to a wireless communication device, downlink transmissions, and receiving, by the network from the wireless communication device, feedback information for the downlink transmissions in an uplink transmission scheduled by a first Downlink Control Information (DCI). The feedback information corresponds to or includes a codebook, which includes at least one of, a first sub-codebook and a second sub-codebook based on reception time of a first DCI.

### CROSS-REFERENCE TO RELATED APPLICATION

This application claims the benefit of priority under 35 U.S.C. § 120 as a continuation of PCT Patent Application No. PCT/CN2023/082618, filed on Mar. 20, 2023, the disclosure of which is incorporated herein by reference in its entirety.

### TECHNICAL FIELD

The disclosure relates generally to wireless communications and, more particularly, to Hybrid Automatic Repeat Requests (HARQ).

### BACKGROUND

Current mobile networks can provide users with almost ubiquitous radio access to data transmission services. As users continue to demand increasingly higher data rates, different techniques have been developed to increase the data rate and reliability of data transmissions between the network and individual user equipment (UE). In 5^{th} Generation Mobile Network System (5GC), HARQ is a key technology in New Radio (NR) systems. HARQ features can improve reliability of data transmissions.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

The arrangements disclosed herein relate to systems, apparatuses, non-transitory computer-readable media, and methods for sending, by a network (e.g., a base station) to a wireless communication device (a User Equipment (UE)), downlink (DL) transmissions, and receiving, by the network from the wireless communication device, feedback information for the DL transmissions in an uplink (UL) transmission scheduled by a first Downlink Control Information (DCI) (e.g., a UL DCI). The feedback information corresponds to or includes a codebook, which includes at least one of, a first sub-codebook and a second sub-codebook based on reception time of a first DCI.

The arrangements disclosed herein relate to systems, apparatuses, non-transitory computer-readable media, and methods for receiving, by a wireless communication device (e.g., a UE) from a network (e.g., a baes station), DL transmissions. The wireless communication device sends to the network feedback information for the DL transmissions in a UL transmission scheduled by a first DCI. The feedback information corresponds to a codebook, which includes a first sub-codebook and a second sub-codebook based on reception time of the first DCI.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication system, according to some arrangements.

FIG. 2 illustrates block diagrams of an example base station and an example UE device, according to some arrangements.

FIG. 3 is a diagram illustrating an example wireless communication method, according to various arrangements.

FIG. 4 is a diagram illustrating an example wireless communication method for feedback information transmission, according to various arrangements.

FIG. 5 is a flowchart diagram illustrating an example wireless communication method, according to various arrangements.

FIG. 6 is a diagram illustrating an example wireless communication method for feedback information transmission, according to various arrangements.

FIG. 7 is a diagram illustrating an example wireless communication method for feedback information transmission, according to various arrangements.

FIG. 8 is a diagram illustrating an example wireless communication method for feedback information transmission, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In a wireless communications system, a wireless communication device (e.g., a UE) can communicate with a network (e.g., a base station). As part of the communication process, the UE and the network can use feedback procedures (e.g., HARQ procedures) to increase data rate and reliability of data transmissions. For example, a HARQ can be included in the Media Access Control (MAC) and Physical (PHY) layers to increase reliability of data transmissions.

In some cases, a HARQ feedback codebook and UL data can be scheduled within a same UL time slot. The codebook and the UL data can be both transmitted by the UE to the network in a Physical Uplink Shared Channel (PUSCH). In some examples, UL data resources can be punctured by HARQ feedback codebook resources. In some examples, UL data resources can be transmitted by rate matching with resources of a HARQ feedback codebook. For a UE scheduled to provide feedback in the PUSCH, some DL transmissions or some DL transmissions scheduled by DL DCIs in DL slots after a UL grant may not be characterized (e.g., included) in the feedback codebook. A UE can determine a HARQ feedback codebook size based on a UL total Downlink Assignment Index (DAI) value. For example, a UL total DAI can be transmitted by the network together with a UL grant in a DCI message to the UE. In some cases, a number of all the DL transmissions for inclusion in a feedback codebook may be indicated (e.g., in a field of the DCI or by the UL total DAI value). However, some wireless communications systems (e.g., NR systems), can support further DL transmissions scheduled by DL DCIs between a UL grant and feedback slot carrying a feedback codebook. Feedback support for such further DL transmissions (e.g., support for both DL transmissions before and after the UL grant slot) is provided by the arrangement disclosed herein to enhance feedback procedures for DL transmissions both before and after a UL grant slot (e.g., a slot of a UL grant). For example, the arrangements disclosed herein can support feedback information for both Physical Downlink Shared Channels (PDSCH) before and after a UL grant in a PUSCH scheduled by the UL grant. The feedback information allows for DL scheduling after UL DCI, which may result in improved system transmission efficiency and reduced feedback delay. In some cases, DL slots after a UL grant are referred to as post-UL-grant-DL slots.

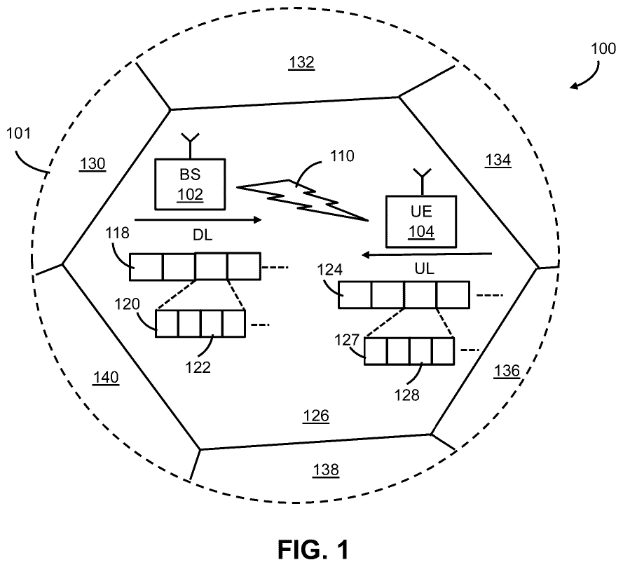

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a base station (BS) 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are located within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a DL radio frame 118, and a UL radio frame 124 respectively. That is, the BS 102 can send data, messages, signals, and information to the UE 104 using the DL radio frame 118, and the UE 104 can send data, messages, signals, and information to the BS 102 using the UL radio frame 124 Each radio frame 118 or 124 can be further divided into a sub-frame 120 or 127. Each sub-frame can include one or more slots. Each sub-frame or slot can include one or more data symbols 122 or 128. In the present disclosure, the BS 102 and UE 104 are described herein as non-limiting examples of communication nodes, which can generally practice the methods disclosed herein. Such communication nodes may be capable of wireless communications, in accordance with various implementations of the present solution. In some implementations, the wireless communication system 100 may support MIMO communication. For example, MIMO is a key technology in NR systems. MIMO may be functional in both Frequency Division Duplex (FDD) and Time Division Duplex (TDD) systems, among others.

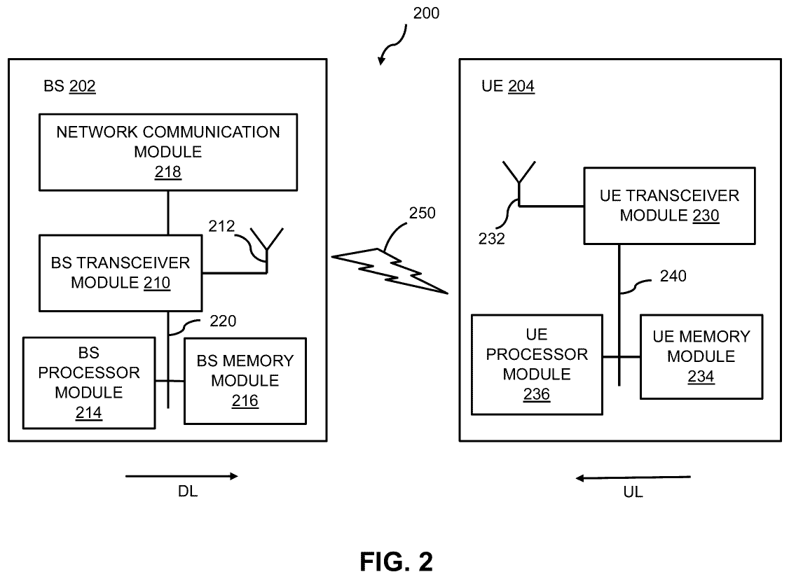

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 is an example of the BS 102. The UE 204 is an example of the UE 104. The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as a UL transceiver 230 that includes a Radio Frequency (RF) transmitter and a RF receiver each including circuitry that is coupled to the antenna 232. A duplex switch (not shown) may alternatively couple the UL transmitter or receiver to the UL antenna in time duplex fashion. Similarly, in accordance with some implementations, the BS transceiver 210 may be referred to herein as a “downlink” transceiver 210 that includes a RF transmitter and a RF receiver each including circuity that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the UL receiver circuitry is coupled to the UL antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), gNB, a serving eNB, a target eNB, a femto station, a Transmission and Reception Point (TRP), a pico station, or another UE, for example. In some implementations, the UE 204 can be various types of user devices such as a mobile phone, a smart phone, a Personal Digital Assistant (PDA), tablet, laptop computer, wearable computing device, a terminal, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

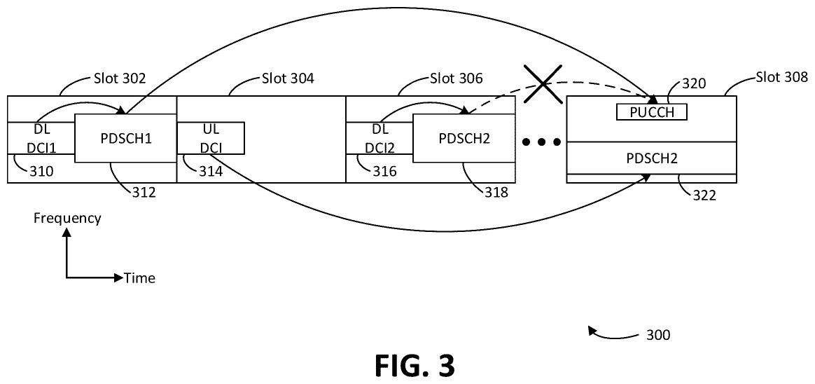

FIG. 3 is a diagram illustrating an example wireless communication method 300, according to various arrangements. The frame structure shown with respect to the wireless communication method 300 includes slots 302, 304, 306, and 308 that correspond to different times. For example, slot 302 may be referred to as slot n, slot 304 may be referred to as slot n+1, slot 306 may be referred to as slot n+2, slot 308 may be referred to as slot n+k, and so on. The wireless communication method 300 can include various transmissions using various resources (e.g., time, frequency, space, code, etc.) of the slots 302, 304, 306, and 308, which are transmission resources. For example, slot 302 can be used by the network (e.g., the BS 102) to transmit a DL DCI 310 (e.g., a first DL DCI) and a PDSCH 312 (e.g., a first PDSCH) scheduled by the DL DCI 310 to the UE 104. The feedback information for the PDSCH 312 is indicated by the DL DCI 310 to be transmitted in a Physical Uplink Control Channel (PUCCH) 320 within slot 308. Slot 304 can be used by the network to transmit a UL DCI 314 to the UE 104. Slot 306 can be used by the network to transmit a DL DCI 316 (e.g., a second DL DCI) and a PDSCH 318 (e.g., a second PDSCH) scheduled by the DL DCI 316 to the UE 104. Slot 308 can be used by the UE 104 to transmit a PUSCH 322 scheduled by the UL DCI 314 to the network. As the PUCCH 320 is located in the same slot as the PUSCH 322, the feedback information originally carried on the PUCCH 320 will be transmitted in the PUSCH 322.

In some cases, the wireless communication method 300 may support HARQ feedback by a UE based on a Transmission Block (TB). In some implementations using time domain duplex (TDD) modes, a many-to-one mapping between DL transmissions (or DL slots) and UL feedback resource (or UL slot) may be present. For example, multiple DL slots may correspond to one UL feedback time slot for the UE. Feedback for the multiple DL transmissions may be aggregated into a HARQ feedback codebook and transmitted in a UL transmission resource (e.g., within a PUCCH or PUSCH) to the network (e.g., the BS 102). The feedback codebook may include a size that refers to a number of bits in the codebook.

In some cases, the wireless communication 300 may support various conditions. For example, to provide feedback information in PUSCH, the HARQ feedback codebook and UL data may be scheduled within a same UL time slot. Both the HARQ feedback codebook and the UL data can be transmitted by the UE 104 to the BS 102 in a UL data resource (e.g., a PUSCH). UL data resources may be punctured by HARQ feedback codebook resources, or UL data resources may be transmitted by rate matching with resources of a HARQ feedback codebook. In some examples, a DL slot refers to a slot (e.g., a timeslot) with a DL assignment (e.g., for DL data transmission in PDSCH). A UL slot refers to a slot with a UL data transmission in PUSCH, UL HARQ feedback in PUCCH, or PUSCH. The disclosure herein may refer to a HARQ feedback codebook as a feedback codebook or a HARQ-ACK feedback codebook, and may refer to a HARQ feedback as feedback or HARQ-ACK feedback. In some cases, the feedback codebook may be one of two types of feedback codebooks, a type-1 codebook or a type-2 codebook.

The feedback codebook size of type-1 codebook may depend on a number of DL transmission slots corresponding to UL feedback time slots according to feedback timing (K1) values set and a number of codewords for each slot and time domain resource allocation list configuration. In carrier aggregation (CA) use cases, a feedback codebook size of type-1 codebook may relate to a number of component carriers (CCs). The BS 102 and the UE 104 may have a unified (e.g., mutual) understanding of the size and bit order of the feedback codebook (e.g., to avoid false retransmissions) of type-1 codebook. The bit order of the of type-1 feedback codebook may refer to a relationship between each bit in a codebook and associated DL slot. The type-1 codebook can include feedback information for all DL slots corresponding to the UL feedback slot in which the type-1 codebook is transmitted by the UE 104. In some example, a portion of DL slots may not include DL data transmissions. Due to the lack of DL data transmissions, feedback bits of a feedback codebook associated with the portion of DL slots may provide garbage information (e.g., useless information, information unrelated to feedback, and so on).

For example, the type-2 codebook may include a DAI mechanism for determining the codebook size and bits order. In a first example, feedback information may be carried on a PUCCH. For example, DAI indication fields (e.g., a counter DAI and a total DAI) may be included in a DCI for scheduling the DL transmission. The counter DAI may indicate a bit order for the feedback information in the codebook. For example, the value of counter DAI in a DL DCI may indicate the position of feedback information within the type-2 codebook for a DL transmission scheduled by the DL DCI. The value of total DAI in a last DL scheduling DCI can indicate a size of the feedback codebook. For example, the value of the total DAI may indicate the number of DL transmissions up to the current transmission (e.g., each transmission to be fed back in one type-2 codebook). A value of the total DAI in a last DL DCI may indicate the size of the type-2 feedback codebook.

In a second example, the feedback information may be carried on PUSCH. For example, one UL DAI field may be introduced in a UL DCI for PUSCH scheduling. In some cases, the value of UL DAI may replace the value of total DAI in the last DL DCI to determine the size of the type-2 codebook. Due to the replacement, after the UL DCI, other DL DCI may not schedule further DL transmissions that are fed back on a PUSCH scheduled by the UL DCI, which may result in avoiding sending garbage feedback bits in a feedback codebook (e.g., as relevant DL slots to the feedback codebook may be indicated).

The DAI can increase overhead of the DCI as DAI field is added into the DL and/or UL DCI. For example, PUSCH 322 in slot 308 (e.g., slot n+k) may be scheduled by the UL DCI 314 in slot 304 (e.g., slot n+1). Because the PUCCH 320 and the PUSCH 322 are overlapping (e.g., overlapping in time), the PDSCH 312 in the slot 302 (e.g., slot n), scheduled by the DL DCI 310 in the slot 302 and starting earlier (e.g., in time) than the UL DCI 314, may be indicated to be fed back on the PUCCH 320 in the slot 308. Due to the indication, the feedback information originally carried on the PUCCH 320 may be included in (e.g., piggybacked on, associated with, or related to) the PUSCH 322. In some cases, the PDSCH 318, scheduled by the DL DCI 316 and starting later (e.g., in time) than or no earlier than the UL DCI 314, may not be fed back in the slot 308. That is, the slot 308 may not include feedback information for the PDSCH 318.

Some wireless communication systems may indicate UL HARQ feedback timing values. For example, in NR, a base station (BS) may indicate, to a UE, UL HARQ feedback timing values (e.g., a feedback slot for transmission of a feedback codebook) via semi-static radio resource control (RRC) signaling, via dynamic DCI (e.g., via a relationship between a particular slot and the feedback slot for transmission of a feedback codebook), or both. Having both options may make feedback timing, and an associated feedback codebook size, more flexible and complex than other communication standards. For example, NR may include more DL assignments (e.g., DL slots) between a UL grant and feedback slot carrying a feedback codebook than the other communication standards. The arrangement herein may support feedback for DL assignments that are both before and after a UL grant slot, instead of only before the UL grant slot.

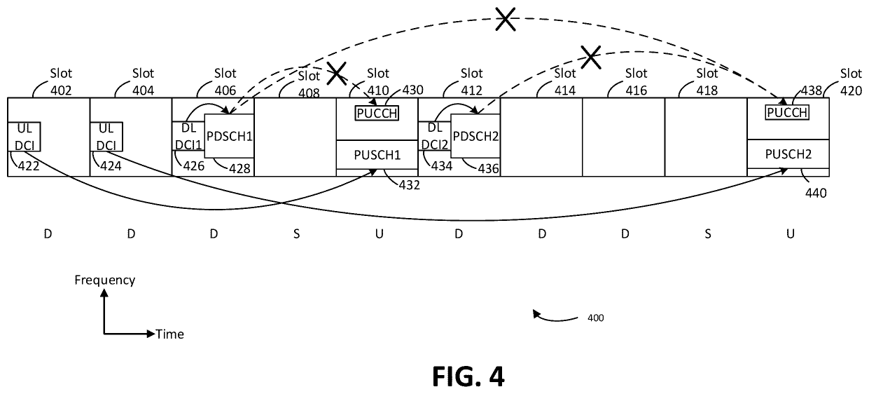

FIG. 4 is a diagram illustrating an example wireless communication method 400 for feedback information transmission, according to various arrangements. The frame structure in the wireless communication method 400 may include slots 402, 404, 406, 408, 410, 412, 414, 416, 418, and 420. For example, slot 402 may be slot n, slot 404 may be slot n+1, slot 406 may be slot n+2, slot 408 may be slot n+3, slot 410 may be slot n+4, slot 412 may be slot n+5, slot 414 may be slot n+6, slot 416 may be slot n+7, slot 418 may be slot n+8, and slot 420 may be slot n+9. The frame structure can be a TDD frame structure having a configuration of DDDSU for the slots 402-420, respectively. As shown in FIG. 4, slots 402-410 includes three DL slots, a special slot, and a UL slot, and slots 412-420 includes three DL slots, a special slot, and a UL slot. The slots 402 through 420 may be associated with different types of transmissions, for example, the slots 402, 402, 406, 412, 414, and 416 may be DL slots. The slots 410 and 420 may be UL slots. Slots 408 and 418 are special slots.

In the wireless communication method 400, various transmissions can be transmitted and received using various resources (e.g., time, frequency, space, code, etc.) of the slot. For example, the network (e.g., the BS 102) can use slots 402 and 404 to transmit to the UE 104 the UL DCI 422 (e.g., a first UL DCI) and 424 (e.g., a second UL DCI). The network can use the slots 406 and 410 to transmit to the UE 104 the DL DCIs 426 (e.g., a first DL DCI) and 434 (e.g., a second DL DCI) as well as PDSCHs 428 (e.g., a first PDSCH) and 436 (e.g., a second PDSCH). The UE 104 can use slots 410 and 420 to transmit to the network PUCCHs 430 (e.g., a first PUCCH) and 438 (e.g., a second PUCCH) and PUSCHs 432 (e.g., a first PUSCH) and 440 (e.g., a second PUSCH).

The wireless communication method 400 may support HARQ feedback. For example, the feedback information for UL DCI 422 can be provided in the PUSCH 432 in slot 410, and the feedback information for UL DCI 424 can be provided in the PUSCH 440 in slot 420. The DL DCI 426 schedules the PDSCH 428, and feedback information for the PDSCH 428 cannot be provided in PUCCH 430 or the PUCCH 438. The DL DCI 434 schedules the PDSCH 436, and feedback information for the PDSCH 436 cannot be provided in PUCCH 438. Therefore, the feedback information (e.g., HARQ acknowledgment (ACK) or negative acknowledgement (NACK)) of PDSCH receptions from slots 406 through 416 cannot be transmitted in neither UL slots 410 nor 420, resulting in HARQ delay.

In some examples, the repetitions of PUSCH can transmit in available UL slots only. PUSCH repetitions may continue to occupying contiguous or immediate adjacent UL slots, leaving no opportunity to transmit PUCCH for an extended period of time. As repetition factor increases (e.g., more repetitions), scheduling restrictions become unacceptable for user experience.

For type-1 codebook, the UE 104 does not generate unicast or multicast HARQ-ACK information for multiplexing in the PUSCH transmission in response to determining that UL DAI for unicast equals to zero or UL DAI for multicast equals to zero, respectively, unless the UE 104 receives, in the Mc occasions for candidate PDSCH receptions in which case the UE 104 generates only the corresponding unicast or multicast HARQ-ACK information, 1) only a unicast or a multicast semi-persistent scheduling (SPS) PDSCH release, 2) only unicast SPS PDSCH(s) or multicast SPS PDSCH(s) having enabled associated HARQ-ACK information reports, 3) only a Transmission Configuration Indicator (TCI) state update or a PDSCH that is scheduled by a DCI format 1_0 with a counter DAI field value of 1 on the Primary Cell (PCell), or 4) only a PDSCH that is scheduled by a DCI format 4_1 having enabled associated HARQ-ACK information report, and counter DAI field value of 1 on the PCell.

For a type-2 codebook, the UE 104 does not multiplex HARQ-ACK information in the PUSCH transmission in response to determining that 1) the UE 104 is not provided a Code Block Group (CBG) configuration (e.g., via, PDSCH-CodeBlockGroupTransmission), 2) the UE 104 is scheduled for a PUSCH transmission by DCI format that includes a UL DAI field with value 4, 3) the UE 104 has not received any PDCCH within the monitoring occasions for a DCI format scheduling PDSCH receptions providing transport blocks with enabled HARQ-ACK information or having associated HARQ-ACK information without scheduling PDSCH receptions on any serving cell c, and 4) the UE 104 does not have HARQ-ACK information in response to a SPS PDSCH reception to multiplex in the PUSCH.

For type-2 codebook, the UE 104 does not multiplex HARQ-ACK information for the first sub-codebook or for the second sub-codebook, respectively, in the PUSCH transmission in response to determining that 1) a UE 104 is provided CBG configuration, 2) the UE 104 is scheduled for a PUSCH transmission by DCI format that includes a UL DAI field with first value 4 or with second value 4, 3) the UE 104 has not received any PDCCH within the monitoring occasions for a DCI format scheduling PDSCH reception providing a transport block with enabled HARQ-ACK information or having associated HARQ-ACK information without scheduling PDSCH reception on any serving cell c, and 4) the UE 104 does not have HARQ-ACK information in response to a SPS PDSCH reception to multiplex in the PUSCH.

In some arrangements, feedback information transmission for DL transmissions and assignments after UL DCI includes dividing a codebook into multiple sub-codebooks. In some arrangements, the codebook (e.g., a type-1 codebook or a type-2 codebook) can be divided into two sub-codebooks.

In some examples, a first sub-codebook corresponds to a first type of DL transmissions starts before or no later than a UL DCI, or a second type of DL transmissions scheduled by DL DCI starts before or no later than the UL DCI. The feedback information of the above DL transmissions are indicated or configured to be transmitted in the same slot of a PUSCH scheduled by the UL DCI. The first type of DL transmissions can be at least one of SPS PDSCHs, SPS PDSCH release, TCI state update, or so on. The second type of DL transmission can be PDSCHs.

In some examples, a second sub-codebook corresponds to a first type of DL transmissions starts no earlier than or after the UL DCI, or a second type of DL transmissions scheduled by DL DCI starts no earlier than or after the UL DCI. The feedback information of the above DL transmissions are indicated or configured to be transmitted in the same slot of a PUSCH scheduled by the UL DCI. The first type of DL transmissions can be at least one of SPS PDSCHs, SPS PDSCH release, TCI state update, or so on. The second type of DL transmission can be PDSCHs.

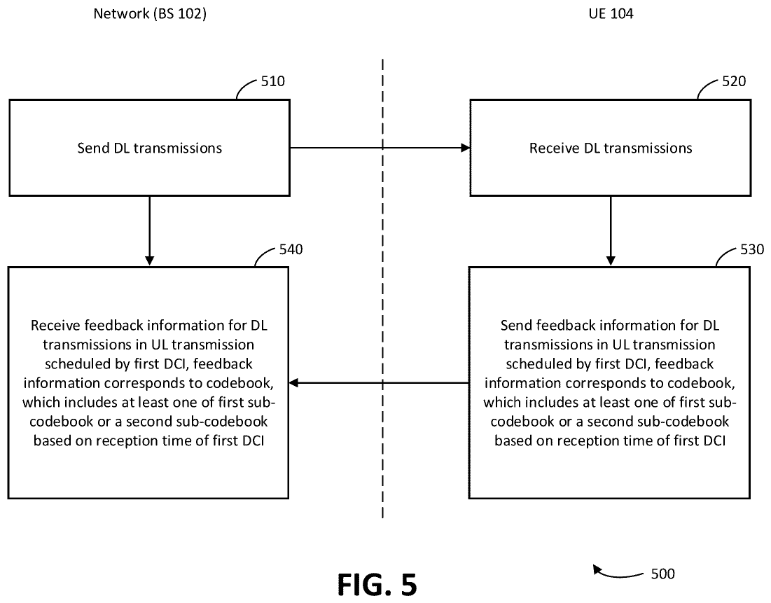

FIG. 5 is a flowchart diagram illustrating an example wireless communication method 500, according to various arrangements. The method 500 can be performed by the network (e.g., the BS 102) and the UE 104. At 510, the network sends DL transmissions. At 520, the UE 104 receives the DL transmissions. At 530, the UE 104 sends feedback information for the DL transmissions in an UL transmission scheduled by a first DCI. The feedback information corresponds to a codebook, which includes at least one of a first sub-codebook and a second sub-codebook based on reception time of a first DCI (e.g., the UL DCI). At 540, the network receives the feedback information for the DL transmissions in the UL transmission scheduled by the first DCI.

In some examples, the DL transmissions includes at least one of a first DL transmission (e.g., a first type of DL transmission for first sub-codebook) starting before or no later than first DCI for the uplink transmission; a second DL transmission (e.g., a second type of DL transmission for first sub-codebook) scheduled by a second DCI (e.g., the DL DCI), the second DCI starting before or no later than the first DCI; a third DL transmission (e.g., a first type of DL transmission for second sub-codebook) starting after or no earlier than the first DCI; or a fourth DL transmission (e.g., a second type of DL transmission for second sub-codebook) scheduled by a third DCI, the third DCI starting after or no earlier than the first DCI. In some examples, the first sub-codebook includes at least one of feedback information for the first DL transmission or feedback information for the second DL transmission. In some examples, the second sub-codebook includes at least one of feedback information for the third DL transmission or feedback information for the fourth DL transmission.

In some arrangements, two sub-codebooks can be cascaded to form a feedback codebook. The cascaded sub-codebooks can be transmitted or multiplexed by the UE 104 on the PUSCH. In some arrangements, two, two sub-codebooks can be transmitted or multiplexed by the UE 104 independently on the PUSCH. For example, two sub-codebooks are independently coded, and transmission resources of each sub-codebook on the PUSCH are determined according to a predefined rule, independently. In some examples, in response to an insufficient resource on the PUSCH for transmitting both of two sub-codebooks, one sub-codebook is discarded according to a predefined rule, for example, a second sub-codebook is discarded fixedly, or a sub-codebook with a relatively small quantity of bits is discarded.

Accordingly, in some arrangements, the codebook is formed by cascading the first sub-codebook and the second sub-codebook. The cascaded first sub-codebook and the second sub-codebook are transmitted by the UE 104 and received by the network. In some arrangements, the first sub-codebook and the second sub-codebook are independently transmitted by the UE 104 and received by the network.

In some arrangements, each sub-codebook contains at least one of feedback information of unicast transmission and feedback information of multicast transmission. Then, the generation of codebook by cascading different types of sub-codebooks in this order: unicast part of the first sub-codebook, multicast part of the first sub-codebook, unicast part of the second sub-codebook, and multicast part of the second codebook. In some arrangements, the codebook cascading order can be unicast part of the first sub-codebook, unicast part of the second sub-codebook, multicast part of the first sub-codebook, and multicast part of the second codebook.

Accordingly, the first sub-codebook includes at least one of feedback information for a first unicast transmission transmitted by the network to the wireless communication device, or feedback information for a first multicast transmission transmitted by the network to the wireless communication device. The second sub-codebook comprises at least one of feedback information for a second unicast transmission transmitted by the network to the wireless communication device, or feedback information for a second multicast transmission transmitted by the network to the wireless communication device.

In some arrangements, a UE capability is defined. The UE capability indicates whether the UE 104 supports providing feedback HARQ-ACK information for DL transmission no earlier than or after a UL grant on the PUSCH scheduled by the UL grant. Therefore, in some arrangements, the UE 104 sends to the network, and the network receives from the UE 104, an indication that the UE 104 supports providing feedback information for DL transmission scheduled by a DCI format starting no earlier than or after an uplink DCI on an uplink resource scheduled by the uplink DCI. In some arrangements, the UE 104 sends to the network, and the network receives from the UE 104, an indication that the UE 104 supports providing the feedback information for the DL transmissions starting no earlier than or after the uplink DCI on the uplink resource scheduled by the uplink DCI.

In some arrangements, if a UE 104 report the UE capability, the UE 104 can divide codebook into two of more sub-codebooks as described herein. If a UE 104 does not report the above UE capability, the codebook (e.g., the feedback information contained therein) carried on the PUSCH contains feedback information for only DL transmissions starting no later than or before the UL grant or the codebook carried on the PUSCH contains feedback information for only DL transmission scheduled by a DCI format starting no later than or before the UL grant.

In some arrangements, the BS 102 can send to the UE 104 a RRC signaling to indicate whether the BS 102 may transmit DL transmission starting no earlier than or after a UL grant and/or to indicate or configure the UE 104 to 1) provide feedback in the PUSCH scheduled by the UL grant, 2) to indicate whether the BS 102 may transmit DL transmission scheduled by a DL DCI starting no earlier than or after a UL grant, and/or 3) to indicate or configure the UE 104 to provide feedback in the PUSCH scheduled by the UL grant. In some arrangements, the BS 102 can send to the UE 104 the RRC signaling to indicate whether the UE 104 can provide the feedback information for the DL transmission after a UL grant if feedback for the DL transmission is indicated or configured to be provided in the PUSCH scheduled by the UL grant. In response to receiving the RRC signaling, the UE 104 generates the codebook by including the first sub-codebook and the second sub-codebook, for example, by including feedback information for both of DL transmissions before or no later than and no earlier than or after the UL DCI.

In some arrangements, the sizes of the first sub-codebook and the second sub-codebook are determined according to the value of UL DAI in the UL DCI. For example, assuming the value of UL DAI is 2, the sizes of the first and the second sub-codebooks can be 4*a+2 and 4*b+2, respectively. Wherein, a, b are non-zero integer. In some examples, a equals to b. In some examples, a is different from b.

In other words, a separate sub-codebook is defined for the feedback corresponding to the DL transmission after the UL DCI, and the feedback can be provided in the PUSCH scheduled by the UL DCI. The restriction on DL scheduling after UL DCI is released, system transmission efficiency is accordingly improved.

In some arrangements, feedback information transmission for DL transmissions or assignments after UL DCI includes generating the type-1 codebook. In some arrangements, the type-1 codebook to be transmitted in a PUSCH scheduled by a UL DCI can be divided into two sub-codebooks, which correspond to feedback information for DL transmissions starts before or no later than the UL DCI and no earlier than or after the UL DCI, respectively, as described herein.

In some arrangements, the size of the first sub-codebook is determined according to the value of a UL DAI in the UL DCI. In some examples, the UE 104 does not generate the first sub-codebook for multiplexing in the PUSCH transmission in response to determining that UL DAI for unicast equals to zero or UL DAI for multicast equals to zero, respectively, unless the UE 104 receives 1) only a unicast or a multicast SPS PDSCH release, 2) only unicast SPS PDSCH(s) or multicast SPS PDSCH(s) having enabled associated HARQ-ACK information reports, 3) only a TCI state update or a PDSCH that is scheduled by a DCI format 1_0 with a counter DAI field value of 1 on the PCell, or 4) only a PDSCH that is scheduled by a DCI format 4_1 having enabled associated HARQ-ACK information report, and counter DAI field value of 1 on the PCell, in the occasions for candidate PDSCH receptions or monitoring occasions before or no later than the UL DCI in which case the UE 104 generates only the corresponding unicast or multicast HARQ-ACK information.

In some arrangements, the size of the codebook (including both of the first sub-codebook and the second sub-codebook) is determined according to the value of a UL DAI in the UL DCI. In some examples, the UE 104 does not generate the codebook for multiplexing in the PUSCH transmission in response to determining UL DAI for unicast equals to zero or UL DAI for multicast equals to zero, unless the UE 104 receives 1) only a unicast or a multicast SPS PDSCH release, 2) only unicast SPS PDSCH(s) or multicast SPS PDSCH(s) having enabled associated HARQ-ACK information reports, 3) only a TCI state update or a PDSCH that is scheduled by a DCI format 1_0 with a counter DAI field value of 1 on the PCell, or 4) only a PDSCH that is scheduled by a DCI format 4_1 having enabled associated HARQ-ACK information report, and counter DAI field value of 1 on the PCell, in the occasions for candidate PDSCH receptions or monitoring occasions before or no later than the UL DCI in which case the UE 104 generates only the corresponding unicast or multicast HARQ-ACK information.

In some arrangements, the size of the codebook (including both of the first sub-codebook and the second sub-codebook) or the size of the first codebook is determined according to the value of a UL DAI in the UL DCI. More specifically, the UE 104 does not generate the codebook or the first sub-codebook for multiplexing in the PUSCH transmission in response to determining that the UL DAI for unicast equals to zero or UL DAI for multicast equals to zero, unless the UL scheduling timing (e.g., slot offset between the UL DCI and the PUSCH) indicated in the UL DCI is larger than at least one value of the value set of the DL scheduling timing (e.g., slot offset between the DL DCI and the PDSCH).

In some arrangements, a size of at least one of the first sub-codebook or the second sub-codebook is determined according to a value of an uplink DAI in the first DCI. In some arrangements, the UE 104 generates the first sub-codebook to be multiplexed in the uplink transmission in response to determining that an uplink scheduling timing indicated in the first DCI is greater than at least one value of a value set of a DL scheduling timing.

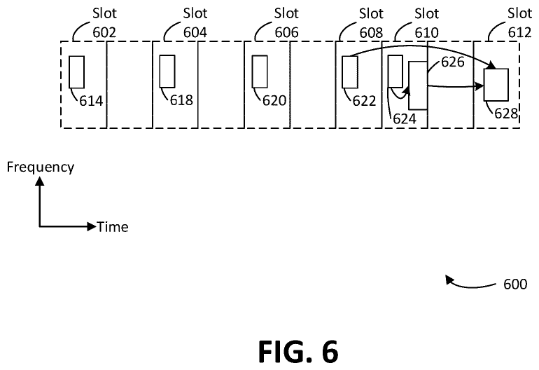

FIG. 6 is a diagram illustrating an example wireless communication method 600 for feedback information transmission, according to various arrangements. The frame structure in the wireless communication method 600 may include slots 602, 604, 606, 608, 610, 612, as well as other slots. The PDCCH 614, 618, 620, and 622 are repetitions. As shown in FIG. 6, assuming the UL scheduling timing k2 is indicated as m (e.g., 3) by the UL DCI. If a UL DCI is transmitted in slot n (e.g., the slot 608, the PDCCH 622), the PUSCH 628 scheduled by the UL DCI is transmitted in slot n+m (e.g., the slot 612). Then, if at least one value of the DL scheduling timing value set (k1 set) is less than m, the UE 104 generates the codebook or the first sub-codebook for multiplexing in the PUSCH transmission regardless of the value of the UL DAI in the UL DCI. In the example in which the k1 set is {2, 3, 4, 5}, there is potential a DL transmission in slot 610 (e.g., a PDSCH 626 scheduled by PDCCH 624). The feedback of the PDSCH 626 is indicated to be in slot 612 (e.g., set k1=2). The second sub-codebook is then generated to provide that feedback. On the other hand, in response to determining that there is no value of the DL scheduling timing value set (K1 set) less than m, the UE 104 does not generate the codebook or the first sub-codebook for multiplexing in the PUSCH transmission, if the value the UL DAI in the UL DCI is zero. In the example in which the k1 set is {4, 5, 6, 7}, no further DL transmission is between PDCCH4 and PUSCH, meaning that second sub-codebook does not need to be generated.

In other words, feedback corresponding to the DL transmission after the UL DCI can be provided in the PUSCH scheduled by the UL DCI. The restriction on DL scheduling after UL DCI is released, system transmission efficiency is accordingly improved.

In some arrangements, feedback information transmission for DL transmissions or assignments after UL DCI includes generating the type-2 codebook. In some arrangements, the type-2 codebook to be transmitted in a PUSCH scheduled by a UL DCI can be divided into two sub-codebooks, which correspond to feedback information for DL transmissions starts before or no later than and no earlier than or after the UL DCI, respectively, as described herein.

In some arrangements, the size of the first sub-codebook can be determined according to the value of a UL DAI in the UL DCI. For example, if the UE 104 is not provided CBG configuration and the UE 104 is scheduled for a PUSCH transmission by a UL DCI that includes a UL DAI field with value 4, and the UE 104 has not received DL transmission (before or no later than receiving the UL DCI), which is indicated or configured to feedback in the PUSCH, the UE 104 does not generate the first sub-codebook for multiplexing in the PUSCH transmission. The DL transmission can be at least one of 1) any PDCCH within the monitoring occasions for a DCI format scheduling PDSCH receptions providing transport blocks with enabled feedback information or having associated feedback information without scheduling PDSCH receptions or 2) SPS PDSCHs. In some arrangements, the first DCI schedules the uplink transmission, the first DCI includes a DAI having a first value (e.g., 4). The UE 104 does not receive a DL transmission before or no later than receiving the first DCI. Feedback for the DL transmission is configured to be transmitted in a same time interval (e.g., a same slot) of the uplink transmission. The UE does not multiplex the first sub-codebook in the uplink transmission.

In some arrangements, the size of the codebook (including both of the first sub-codebook and the second sub-codebook) is determined according to the value of a UL DAI in the UL DCI. For example, if a UE 104 is not provided CBG configuration and the UE 104 is scheduled for a PUSCH transmission by a UL DCI that includes a UL DAI field with value 4, and the UE 104 has not received DL transmission (before or no later than receiving the UL DCI), which is indicated or configured to feedback in the PUSCH, the UE 104 does not generate the codebook for multiplexing in the PUSCH transmission. The DL transmission can be at least one of 1) any PDCCH within the monitoring occasions for a DCI format scheduling PDSCH receptions providing transport blocks with enabled feedback information or having associated feedback information without scheduling PDSCH receptions, or 2) SPS PDSCHs. In some arrangements, the first DCI schedules the uplink transmission, the first DCI includes a DAI having a first value (e.g., 4). The UE 104 does not receive a DL transmission before or no later than receiving the first DCI. Feedback for the DL transmission is configured to be transmitted in a same time interval (e.g., a same slot) of the uplink transmission. The UE does not multiplex the codebook in the uplink transmission.

In some arrangements, the size of the codebook (including both of the first sub-codebook and the second sub-codebook) is determined according to the value of a UL DAI in the UL DCI. For example, if a UE 104 is not provided CBG configuration and the UE 104 is scheduled for a PUSCH transmission by a UL DCI that includes a UL DAI field with value 4, and the UE 104 has not received DL transmission (including, both of before (no later than) or after (no earlier than) the UL DCI), which is indicated or configured to feedback in the PUSCH, the UE 104 does not generate the codebook for multiplexing in the PUSCH transmission. The DL transmission can be at least one of 1) any PDCCH within the monitoring occasions for a DCI format scheduling PDSCH receptions providing transport blocks with enabled feedback information or having associated feedback information without scheduling PDSCH receptions, or 2) SPS PDSCHs.

In some arrangements, if a UE 104 is scheduled for a PUSCH transmission by a UL DCI that includes a UL DAI field with value other than 4 or the UE 104 has received at least one DL transmission (including, both of before (or no later than) and after (no earlier than) the UL DCI), which is indicated or configured to feedback in the PUSCH, the UE 104 generates the codebook for multiplexing in the PUSCH transmission. In some arrangements, the first DCI schedules the uplink transmission, the first DCI includes a DAI having a second value (e.g., a value other than 4), or the UE receives a DL transmission before (or no later than) or after (or no earlier than) receiving the first DCI, the feedback for the DL transmission is configured in the uplink transmission. The wireless communication device does not generate the codebook for multiplexing in the uplink transmission.

In some arrangements, if the UE 104 is scheduled for a PUSCH transmission by a UL DCI that includes a UL DAI field with value 4 and the UE 104 has not received a DL transmission before or no later than receiving the UL DCI, which is indicated or configured to feedback in the PUSCH, the UE 104 does not generate the codebook (including both of the first sub-codebook and the second sub-codebook) for multiplexing in the PUSCH transmission. In some arrangements, the first DCI schedules the uplink transmission, the first DCI includes a DAI having a first value (e.g., 4). The UE 104 does not receive a DL transmission before or no later than receiving the first DCI, which is configured to be fed back in a same time interval of the uplink transmission. The UE does not multiplex the codebook (including both of the first sub-codebook and the second sub-codebook) in the uplink transmission.

In some arrangements, the first sub-codebook is generated according to the value of UL DAI in the UL DCI, and the second sub-codebook is generated according to the rule for generating type-1 codebook.

In some arrangements, if a UE 104 is scheduled for a PUSCH transmission by a UL DCI that includes a UL DAI field with value other than 4 or the UE 104 has received DL transmission before or no later than receiving the UL DCI, which is indicated or configured to feedback in the PUSCH, the UE 104 generates the first sub-codebook according to the value of UL DAI in the UL DCI. The second sub-codebook is generated according to the rule for generating type-1 codebook. In some arrangements, the first DCI schedules the uplink transmission, the first DCI includes a DAI having a second value (e.g., other than 4), or the UE 104 receives at least one DL transmission before or no later than receiving the first DCI. Feedback for the DL transmission is configured to be transmitted in a same time interval of the uplink transmission. The UE 104 generates the codebook including generating the first sub-codebook according to a value of an uplink DAI of the first DCI and generating the second sub-codebook according to a rule for type-1 codebook.

In some arrangements, if a UE 104 is scheduled for a PUSCH transmission by a UL DCI that includes a UL DAI field with value other than 4 or the UE 104 has received DL transmission only before or no later than receiving the UL DCI, which is indicated or configured to feedback in the PUSCH, the UE 104 only generates the first sub-codebook according to the value of UL DAI in the UL DCI. The second sub-codebook is not generated. In some arrangements, the first DCI schedules the uplink transmission, the first DCI includes a DAI having a second value (e.g., other than 4), or the UE receives a DL transmission before or no later than receiving the first DCI. Feedback for the DL transmission is configured to be transmitted in a same time interval of the uplink transmission. The UE 104 only generates the first sub-codebook according to a value of an uplink DAI of the first DCI.

In some arrangements, if a UE 104 is scheduled for a PUSCH transmission by a UL DCI that includes a UL DAI field with value other than 4 or the UE 104 has received DL transmission only before or no later than receiving the UL DCI, which is indicated or configured to feedback in the PUSCH. The UE 104 generates both of the first sub-codebook and the second sub-codebook. In some arrangements, the UE 104 receives at least one DL transmission only before or no later than receiving the first DCI. Feedback for the at least one DL transmission is configured to be transmitted in a same time interval (e.g., slot) of the uplink transmission. The UE 104 generates both of the first sub-codebook and the second sub-codebook.

In some arrangements, if a UE 104 has only received DL transmission after or no earlier than receiving the UL DCI, which is indicated or configured to feedback in the PUSCH, the UE 104 only generates the second sub-codebook. For example, the second sub-codebook is generated according to the rule for generating type-1 codebook. In some arrangements, the UE 104 receives at least one DL transmission only after or no earlier than receiving the first DCI. Feedback for the at least one DL transmission is configured to be transmitted in a same time interval of the uplink transmission. The UE 104 generates the second sub-codebook without generating the first codebook.

In some arrangements, whether the second sub-codebook is generated depends on whether a UE 104 has received DL transmission after or no earlier than receiving the UL DCI, the feedback for which is indicated or configured to be provided in the PUSCH. In some arrangements, the UE 104 generates the second sub-codebook based on whether the UE 104 receives a DL transmission after or no earlier than receiving the first DCI. Feedback for the DL transmission is configured to be transmitted in a same time interval of the uplink transmission.

In some arrangements, if the UE 104 is scheduled for a PUSCH transmission by a UL DCI that includes a UL DAI field with value 4 and the UE 104 has only received DL transmission after or no earlier than receiving the UL DCI, the feedback for which is indicated or configured to be provided in the PUSCH, the UE 104 generates only the second sub-codebook. For example, the second sub-codebook is generated according to the rule for generating type-1 codebook.

In some arrangements, if the UE 104 is provided CBG configuration, the UE 104 generates TB sub-codebook and CBG sub-codebook according to a first value of UL DAI for TB and a second value of UL DAI for CBG, respectively. The TB sub-codebook and CBG sub-codebook can be generated using the methods described herein, independently. More specifically, the TB sub-codebook includes at least one of the first TB sub-codebook and the second TB sub-codebook. And the CBG sub-codebook includes at least one of the first CBG sub-codebook and the second CBG sub-codebook.

In other words, feedback corresponding to the DL transmission after the UL DCI can be provided in the PUSCH scheduled by the UL DCI. The restriction on DL scheduling after UL DCI is released, system transmission efficiency is accordingly improved.

In some arrangements, feedback information transmission for DL transmissions or assignments after UL DCI includes generating the codebook in the examples in which PUSCH transmission with repetition is scheduled by the UL grant. In some arrangements, the codebook (e.g., a type-1 codebook or a type-2 codebook) to be transmitted in a PUSCH scheduled by a UL DCI can be divided into two sub-codebooks, which respectively correspond to feedback information for DL transmissions starting before (or no later than) and after (no earlier than) the UL DCI.

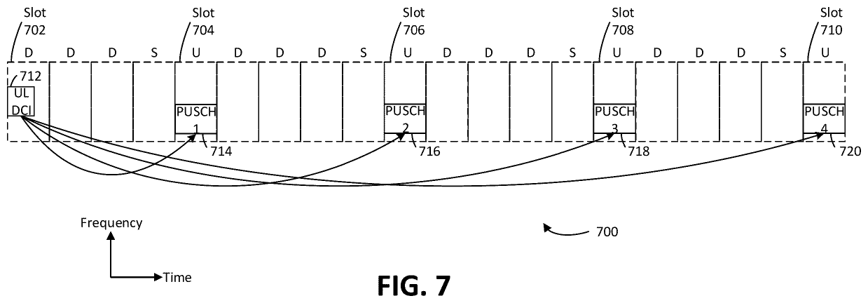

FIG. 7 is a diagram illustrating an example wireless communication method 700 for feedback information transmission, according to various arrangements. The frame structure in the wireless communication method 700 may include slots 702, 704, 706, 708, 710, and other slots as shown. The frame structure can be a TDD frame structure having a configuration of DDDSU for the slots shown. In some examples, PUSCH transmission with repetition (e.g., PUSCH 714, 716, 718, and 720) can be scheduled by a UL DCI 712. In this example, the repetition factor is 4. Then, the four times of PUSCH transmissions 714, 716, 718, and 720 are located within four UL slots 702, 704, 706, and 708, respectively.

In some arrangements, the first sub-codebook is transmitted in only the initial PUSCH transmission (e.g., the first PUSCH transmission or PUSCH rep #1, shown as PUSCH 714). The second sub-codebook is transmitted in a subsequent PUSCH transmission (i.e., non-initial PUSCH transmission such as PUSCH 716, 718, or 720). In some arrangements, the first sub-codebook is received by the network (e.g., the BS 102) from the UE 104 in a first PUSCH transmission (e.g., 714). The second sub-codebook is received by the network from the UE 104 in a subsequent PUSCH transmission (e.g., PUSCH 716, 718, or 720). The subsequent PUSCH transmission is a repetition of the first PUSCH transmission and is later than the first PUSCH transmission.

In some arrangements, if a DL transmission which is indicated or configured to be fed back in slot of a PUSCH transmission, the feedback information of the DL transmission is transmitted in the PUSCH transmission. For example, the feedback information of a DL transmission which is indicated or configured to be provided in slot of PUSCH rep #1 (e.g., PUSCH 714) is transmitted in PUSCH rep #1. The feedback information of another DL transmission which is indicated or configured to be provided in slot of PUSCH rep #2 (e.g., PUSCH 716) is transmitted in PUSCH rep #2, and so on. In some arrangements, the network indicates or configures to the UE 104 that feedback for a DL transmission of the DL transmissions corresponds to a time interval (e.g., a slot) of a PUSCH transmission. The network receives from the UE 104 the feedback for the DL transmission in the PUSCH transmission.

In some arrangements, the size of codebook or sub-codebook transmitted in each repetition of the PUSCH transmission is determined according to the value of UL DAI in the UL DCI that schedules the PUSCH repetition. In the example in which the value of UL DAI is 2, the size of codebook or sub-codebook transmitted in the first PUSCH repetition can be 4*n+2. The size of codebook or sub-codebook transmitted in the second PUSCH repetition can be 4*m+2, and so on. The parameters n and m are non-zero integers. In some examples, n equals to m. In some examples, n is different from m.

In some arrangements, the first sub-codebook is transmitted in only the initial PUSCH transmission (e.g., the first PUSCH transmission or PUSCH rep #1, shown as PUSCH 714). The second sub-codebook is transmitted in the last PUSCH transmission (e.g., PUSCH rep #4 or PUSCH 720). The second sub-codebook contains the feedback information of DL transmission which is indicated or configured to be provided in either slot of each PUSCH repetition. The DL transmission starts no earlier than or after the UL grant for scheduling the PUSCH repetition. In some arrangements, the first sub-codebook is received by the network from the UE 104 in a first PUSCH transmission (e.g., PUSCH 714)), the first PUSCH transmission is a first transmission of a PUSCH repetition. The second sub-codebook is received by the network from the UE 104 in a second PUSCH transmission (e.g., PUSCH 720), the second PUSCH transmission is a last transmission of the PUSCH repetition.

In some arrangements, the sizes of codebook or sub-codebook transmitted in the first PUSCH transmission and the last PUSCH transmission are determined according to the value of UL DAI in the UL DCI that schedules the PUSCH repetition. In the example in which the value of UL DAI is 2, the size of codebook or sub-codebook transmitted in the first PUSCH repetition can be 4*x+2. The size of codebook or sub-codebook transmitted in the last PUSCH repetition can be 4*y+2, and so on. The parameters x and y are non-zero integers. In some examples, x equals to y. In some examples, x is different from y.

In some arrangements, the feedback information of DL transmission which is indicated or configured to be fed back in slot of the initial PUSCH transmission (e.g., the first PUSCH transmission or PUSCH rep #1, shown as PUSCH 714) is transmitted in PUSCH rep #1. In some arrangements, the network indicates to the UE 104 that feedback for a DL transmission of the DL transmissions corresponds to a time interval of a first PUSCH transmission (e.g., PUSCH 714). The network receives from the UE 104 the feedback for the DL transmission in the first PUSCH transmission.

The feedback information of DL transmission which is indicated or configured to be provided in either slot of the non-initial PUSCH transmission (e.g., PUSCH rep #2 (716) or PUSCH rep #3 (718) or PUSCH rep #4 (720)) is transmitted in the last PUSCH transmission (e.g., PUSCH rep #4 (720)). In some arrangements, the network indicates to the UE 104 that feedback for a DL transmission of the DL transmissions corresponds to a time interval (e.g., a slot) of a subsequent PUSCH transmission (e.g., PUSCH 716, 718, or 720). The subsequent PUSCH transmission is a PUSCH transmission other than a first transmission of a PUSCH repetition. The network receives from the UE 104 the feedback for the DL transmission in a last PUSCH transmission (e.g., PUSCH 714). The last PUSCH transmission is a last transmission of the PUSCH repetition.

In other words, feedback corresponding to the DL transmission after the UL DCI can be provided in the PUSCH scheduled by the UL DCI. The restriction on DL scheduling after UL DCI is released, system transmission efficiency is accordingly improved.

In some examples, two or more slots can be occupied by a PUSCH transmission or a TB, in a TB over Multiple Slots (TBoMS) scheduling. As shown in FIG. 7, a PUSCH or a TB is scheduled to be transmitted in four UL slots 702, 704, 706, and 708, respectively. The PUSCH 714 can be PUSCH part 1, the PUSCH 716 can be PUSCH part 2, the PUSCH 718 can be PUSCH part 3, and the PUSCH 720 can be PUSCH part 4.

In some arrangements, the first sub-codebook is only transmitted in the PUSCH part 1 (e.g., PUSCH 714). The second sub-codebook is transmitted in one or more subsequent PUSCH parts 2, 3, 4.

In some arrangements in which feedback information for a DL transmission is indicated or configured to be provided in a slot of a particular PUSCH part, the feedback information of the DL transmission can be transmitted in that PUSCH part. In the example in which the feedback information of a DL transmission is indicated or configured to be provided in slot of PUSCH part 1, the feedback information will be transmitted in PUSCH part 1. The feedback information of another DL transmission which is indicated or configured to be provided in slot of PUSCH part 2 will be transmitted in PUSCH part 2, and so on (e.g., PUSCH 716).

In some arrangements in which the first sub-codebook is transmitted only in PUSCH part 1. The second sub-codebook is transmitted in the last PUSCH part, PUSCH part 4 (e.g., PUSCH 720). The second sub-codebook contains the feedback information of DL transmission indicated or configured to be provided in any slot of PUSCH part other than PUSCH part 1. The DL transmission starts no earlier than or after the UL grant (e.g., the UL DCI 712) for scheduling the PUSCH 714, 716, 718, and 720.

In some arrangements in which the feedback information of DL transmission is indicated or configured to be provided in slot of PUSCH part 1, the feedback information is transmitted in PUSCH part 1. The feedback information of DL transmission which is indicated or configured to be provided in any slot of the PUSCH part other than PUSCH part 1 (e.g., PUSCH part 2, PUSCH part 3, or PUSCH part 4) is transmitted in the last PUSCH part (e.g., PUSCH part 4).

In some arrangements, the size of codebook or sub-codebook transmitted in each PUSCH part are determined according to the value of UL DAI in the UL DCI scheduling the PUSCH. For example, assuming the value of UL DAI is 2, the size of codebook or sub-codebook transmitted in the PUSCH part 1 can be 4*p+2; The size of codebook or sub-codebook transmitted in the PUSCH part 2 can be 4*q+2, and so on. Wherein, p, q are non-zero integer. In some examples, p equals to q. In some examples, p is different from q.

In some arrangements, feedback information transmission includes generating type-2 codebook for DL transmissions or assignments after UL DCI. In some arrangements, the size of type-2 codebook is determined according to at least one of the UL DAI in the UL DCI and the total DAI in the last DL DCI. In some arrangements, the codebook includes a type-2 codebook. The size of the codebook is determined according to at least one of an uplink DAI in the first DCI or a DAI in a last DL DCI for a DL transmission, which is to be fed back in a same time interval of an uplink transmission scheduled by the first DCI.

In some arrangements, if the UL DCI starts before or no later than the last DL DCI, the size of type-2 codebook is determined according to the total DAI in the last DL DCI. If the UL DCI starts no earlier than or after the last DL DCI, the size of type-2 codebook is determined according to the UL DAI in the UL DCI. In some examples, at least one of the count DAI and the total DAI in the DL DCI starts no earlier than or after the UL DCI is counting from a value of UL DAI in the UL DCI.

In some arrangements, the first DCI starts before or no later than the last DL DCI, and the size of the codebook is determined according to the DAI in the last DL DCI. In some arrangements, the first DCI starts after or no earlier than the last DL DCI, and the size of the codebook is determined according to the uplink DAI in the first DCI. In some arrangements, the last DCI starts after or no earlier than the first DCI, the DAI in a DL DCI starts after or no earlier than the first DCI counts from a value of the uplink DAI in the first DCI.

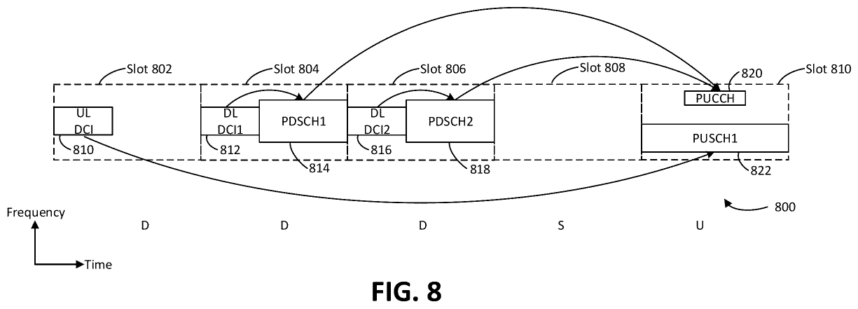

FIG. 8 is a diagram illustrating an example wireless communication method 800 for feedback information transmission, according to various arrangements. The frame structure in the wireless communication method 800 may include slots 802, 804, 806, 808, and 810. For example, slot 802 may be slot n, slot 804 may be slot n+1, slot 806 may be slot n+2, slot 808 may be slot n+3, slot 810 may be slot n+4. The frame structure can be a TDD frame structure having a configuration of DDDSU for the slots 402-410, respectively. As shown in FIG. 8, slots 802-810 includes three DL slots, a special slot, and a UL slot. The slots 802 through 810 may be associated with different types of transmissions, for example, the slots 802, 802, and 806 are DL slots. The slot 810 is a UL slot. Slot 818 is a special slot.

In the wireless communication method 800, various transmissions can be transmitted and received using various resources (e.g., time, frequency, space, code, etc.) of the slot. For example, the network (e.g., the BS 102) can use slot 802 to transmit to the UE 104 the UL DCI 810. The network can use the slots 804 and 806 to transmit to the UE 104 the DL DCIs 812 (e.g., a first DL DCI) and 816 (e.g., a second DL DCI) as well as PDSCHs 814 (e.g., a first PDSCH) and 818 (e.g., a second PDSCH). The UE 104 can use slot 810 to transmit to the network PUCCH 820 and PUSCH 822.

The wireless communication method 800 may support HARQ feedback. For example, the feedback information for UL DCI 810 can be provided in the PUSCH 822 in slot 810. The DL DCI 812 schedules the PDSCH 814, and feedback information for the PDSCH 814 is provided in PUCCH 820. The DL DCI 816 schedules the PDSCH 818, and feedback information for the PDSCH 818 is provided in PUCCH 820.

As an example shown in FIG. 8, there are two DL DCIs 812 and 816 that start no earlier than or after UL DCI 810. Feedback for the PDSCHs 814 and 818 scheduled by the DL DCIs 812 and 816 respectively are indicated to be provided in the slot 810 of PUSCH 822 scheduled by UL DCI 810. The UE 104 generates the codebook according to the value of total DAI (e.g., total DAI2=4) in the last DL DCI (e.g., DL DCI 916). The size of codebook can be determined as 4*p+4. As the DAI is cyclically counted in units of 4, total DAI being equal to 4 represents that a quantity of bits that need to be fed back is 4*p+4, and a value of p is determined by a quantity of DL transmissions received by the UE 104.

In some arrangements, the type-2 codebook to be transmitted in a PUSCH scheduled by a UL DCI can be divided into two sub-codebooks, which correspond to feedback information for DL transmissions starts before or no later than and no earlier than or after the UL DCI, respectively. The size of the first sub-codebook is determined according to the UL DAI in the UL DCI. The size of the second sub-codebook is determined according to the total DAI in the last DL DCI. In some examples, at least one of the count DAI and the total DAI in DL DCI corresponding to the second sub-codebook is counting from 1. In some arrangements, a size of the first sub-codebook is determined according to an uplink DAI in the first DCI. A size of the second sub-codebook is determined according to a DAI in a last DL DCI for a DL transmission. The DAI in a DL DCI for the DL transmission corresponding to the second sub-codebook counts from 1.

As an example shown in FIG. 8, there are two DL DCIs 812 and 816 that start no earlier than or after UL DCI 810 and the PDSCHs 814 and 818 scheduled by the DL DCIs 812 and 816, respectively. Feedback for the PDSCHs 814 and 818 scheduled by the DL DCIs 812 and 816 respectively are indicated to be provided in the slot 810 of PUSCH 822 scheduled by UL DCI 810. The UE 104 generates the second codebook by including feedback information for these DL transmissions (e.g., PDSCHs 814 and 818) and will be transmitted in PUSCH 822. The size of the first sub-codebook is determined as 4*n+2 according to the value of UL DAI (e.g., 2) in the UL DCI 810. The size of the second sub-codebook is determined as 4*m+2 according to the value of total DAI (e.g., total DAI2) in the last DL DCI 816. As the DAI is cyclically counted in units of 4, that UL DAI is equal to 2 represents that a quantity of bits that need to be fed back is 4*n+2 or 4*m+2, and a value of n or m is determined by a quantity of DL transmissions received by the UE 104. Then, the codebook size is determined as 4*n+2+4*m+2=4*(n+m)+4.

In some arrangements, the type-2 codebook to be transmitted in a PUSCH scheduled by a UL DCI can be divided into two sub-codebooks, the first sub-codebook and the second sub-codebook, which correspond to feedback information for DL transmissions starting before or no later than and feedback information for DL transmissions starting no earlier than or after the UL DCI, respectively. The size of the first sub-codebook is determined according to the total DAI in the first last DL DCI, which is the last DL DCI among DL DCIs before or no later than the UL DCI. The size of the second sub-codebook is determined according to the total DAI in the second last DL DCI which is no earlier than or after the UL DCI. In some examples, at least one of the count DAI and the total DAI in DL DCI corresponding to the second sub-codebook starting from 1.

Accordingly, the arrangements described herein allow the feedback information for the DL transmissions received by the UE after the UL DCI to be provided in the PUSCH scheduled by the UL DCI. The restriction on DL scheduling after UL DCI is released, system transmission efficiency can improved.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
receiving, by a wireless communication device from a network, a downlink transmission; and
multiplexing, by the wireless communication device, feedback information for the downlink transmission in an uplink transmission scheduled by a first Downlink Control Information (DCI), wherein the downlink transmission is scheduled by a second DCI, the second DCI starting after the first DCI, and
wherein the uplink transmission is a repetition of a physical uplink shared control channel (PUSCH) transmission.

2. The wireless communication method of claim 1, comprising transmitting, by the wireless communication device an indication that the wireless communication device supports providing feedback information for a downlink transmission scheduled by a DCI format starting after an uplink grant.

3. The wireless communication method of claim 1, wherein
the feedback information corresponds to a type-2 codebook; and
a size of the type-2 codebook is determined according to an uplink Downlink Assignment Index (DAI) in the first DCI.

4. The wireless communication method of claim 1, comprising receiving, by the wireless communication device from the network, a signaling,
wherein the signaling is to indicate whether the wireless communication device is to provide the feedback information for the DL transmission after an UL grant.

5. The wireless communication method of claim 1, wherein the feedback information for the downlink transmission is indicated to be transmitted in the same slot of the PUSCH transmission, scheduled by the first DCI.

6. A wireless communication device, comprising:
at least one processor configured to:
receive, via a transceiver from a network, a downlink transmission; and
multiplex feedback information for the downlink transmission in an uplink transmission scheduled by a first Downlink Control Information (DCI),
wherein the downlink transmission is scheduled by a second DCI, the second DCI starting after the first DCI, and
wherein the uplink transmission is a repetition of a physical uplink shared control channel (PUSCH) transmission.

7. The wireless communication device of claim 6, wherein the at least one processor is configured to transmit, via the transceiver, an indication that the wireless communication device supports providing feedback information for a downlink transmission scheduled by a DCI format starting after an uplink grant.

8. The wireless communication device of claim 6, wherein
the feedback information corresponds to a type-2 codebook; and
a size of the type-2 codebook is determined according to an uplink Downlink Assignment Index (DAI) in the first DCI.

9. The wireless communication device of claim 6, wherein the at least one processor is configured to receive, via the transceiver from the network, a signaling, wherein the signaling is to indicate whether the wireless communication device is to provide the feedback information for the DL transmission after an UL grant.

10. The wireless communication device of claim 6, wherein the feedback information for the downlink transmission is indicated to be transmitted in the same slot of the PUSCH transmission, scheduled by the first DCI.

11. A wireless communication method, comprising:
sending, by a network node to a wireless communication device, a downlink transmission; and
receiving, by the network node from the wireless communication device, feedback information for the downlink transmission multiplexed in an uplink transmission scheduled by a first Downlink Control Information (DCI),
wherein the downlink transmission is scheduled by a second DCI, the second DCI starting after the first DCI, and
wherein the uplink transmission is a repetition of a physical uplink shared control channel (PUSCH) transmission.

12. The wireless communication method of claim 11, comprising receiving an indication that the wireless communication device supports providing feedback information for a downlink transmission scheduled by a DCI format starting after an uplink grant.

13. The wireless communication method of claim 11, wherein
the feedback information corresponds to a type-2 codebook; and
a size of the type-2 codebook is determined according to an uplink Downlink Assignment Index (DAI) in the first DCI.

14. The wireless communication method of claim 11, comprising sending, by the network to the wireless communication device, a signaling,
wherein the signaling is to indicate whether the wireless communication device is to provide the feedback information for the DL transmission after an UL grant.

15. The wireless communication method of claim 11, wherein the feedback information for the downlink transmission is indicated to be transmitted in the same slot of the PUSCH transmission, scheduled by the first DCI.

16. A network node, comprising:
at least one processor configured to:
send, via a transceiver to a wireless communication device, a downlink transmissions;
receive, via the transceiver from the wireless communication device, feedback information for the downlink transmission multiplexed in an uplink transmission scheduled by a first Downlink Control Information (DCI),
wherein the downlink transmission is scheduled by a second DCI, the second DCI starting after the first DCI, and
wherein the uplink transmission is a repetition of a physical uplink shared control channel (PUSCH) transmission.

17. The network node of claim 16, wherein the at least one processor is configured to receive, via the transceiver, an indication that the wireless communication device supports providing feedback information for a downlink transmission scheduled by a DCI format starting after an uplink grant.

18. The network node of claim 16, wherein
the feedback information corresponds to a type-2 codebook; and
a size of the type-2 codebook is determined according to an uplink Downlink Assignment Index (DAI) in the first DCI.

19. The network node of claim 16, wherein the at least one processor is configured to send, via the transceiver to the wireless communication device, a signaling, wherein the signaling is to indicate whether the wireless communication device is to provide the feedback information for the DL transmission after an UL grant.

20. The network node of claim 16, wherein the feedback information for the downlink transmission is indicated to be transmitted in the same slot of the PUSCH transmission, scheduled by the first DCI.
